(19) United States
(12) Patent Application Publication
(10) Pub. No.: US 2014/0023430 A1
(43) Pub. Date: Jan. 23, 2014

(54) Attachment Techniques

(71) Applicants: Christopher D. Prest, San Francisco, CA (US); Dale N. Memering, San Francisco, CA (US); David A. Pakula, San Francisco, CA (US); Fletcher Rothkopf, Los Altos, CA (US); Matthew D. Hill, Mountain View, CA (US); Stephen B. Lynch, Portola Valley, CA (US); Tang Yew Tan, Palo Alto, CA (US)

(72) Inventors: Christopher D. Prest, San Francisco, CA (US); Dale N. Memering, San Francisco, CA (US); David A. Pakula, San Francisco, CA (US); Fletcher Rothkopf, Los Altos, CA (US); Matthew D. Hill, Mountain View, CA (US); Stephen B. Lynch, Portola Valley, CA (US); Tang Yew Tan, Palo Alto, CA (US)

(73) Assignee: Apple Inc., Cupertino, CA (US)

(21) Appl. No.: 13/553,728

(22) Filed: Jul. 19, 2012

(51) Int. Cl. F16B 11/00; B29C 47/02; B32B 38/04; B32B 37/14; B23K 31/02

(52) U.S. Cl. 403/265; 156/60; 228/121; 156/242; 264/259; 264/148; 264/176.1

(57) ABSTRACT

Techniques for attachment of sapphire substrates with other materials and the resulting structures are provided. One embodiment may take the form of an attachment method including creating an aperture within a sapphire substrate and filling the aperture with an attachment material. The method also includes mechanically coupling a member to the sapphire substrate using the attachment material.

### TECHNICAL FIELD

The present description is generally related to attachment techniques and more particularly to attachment techniques for sapphire.

### BACKGROUND

Certain materials may present interesting issues when attempting to mechanically couple the material with another material. For example, when attaching two different materials together, there is a risk that the attachment technique may not be effective. This may be especially true when the two materials have different characteristics such as thermal coefficients of expansion, stiffness and so forth. Sapphire, for example, may be particularly difficult to mechanically couple with other materials. Specifically, machining sapphire may be difficult due to its crystalline structure, hardness and strength. Further, sapphire may have a high level of stiffness relative to other materials, as well as a relatively low level of thermal expansion. As such, conventional adhesive attachment techniques may not be effective or lasting. That is, mechanical strain on the adhesive bond resulting from the difference in the thermal expansion and stiffness of the materials eventually causes failure of the bond.

### SUMMARY

Techniques for attachment of sapphire substrates are provided. One embodiment may take the form of an attachment method including creating an aperture within a sapphire substrate and filling the aperture with an attachment material. The method also includes mechanically coupling a member to the sapphire substrate using the attachment material.

Another embodiment may take the form of a method including creating an attachment feature in a sapphire substrate and coupling the sapphire substrate into a mold. The method also includes forming a structure within the mold and removing the mold.

Yet another embodiment may take the form of an extrusion method for providing attachment features for a sapphire member. The method includes coupling metal about the sapphire member to form a rough member and extruding the rough member through a die to form an extruded member having the sapphire member mechanically bonded to the metal.

Still another embodiment may take the form of a device comprising a mechanical coupling between two materials. The device includes a first member having one or more attachment features. The attachment features are filled with one of a plastic or a metal. Additionally, the device includes a second member coupled to the first member by the plastic or metal.

While multiple embodiments are disclosed, still other embodiments of the present invention will become apparent to those skilled in the art from the following Detailed Description. As will be realized, the embodiments are capable of modifications in various aspects, all without departing from the spirit and scope of the embodiments. Accordingly, the drawings and detailed description are to be regarded as illustrative in nature and not restrictive.

### BRIEF DESCRIPTION OF THE DRAWINGS

FIG. 1A illustrates a first side of an example electronic device having a sapphire cover.

FIG. 1B illustrates a second side of the example electronic device of FIG. 1.

FIG. 2A is a cross-sectional view taken along line II-II in FIG. 1A illustrating an example attachment feature for the sapphire cover.

FIG. 2B is a cross-sectional view taken along line II-II in FIG. 1A illustrating another example attachment feature for the sapphire cover.

FIG. 2C is a cross-sectional view taken along line II-II in FIG. 1A illustrating yet another example attachment feature for the sapphire cover.

FIG. 2D is a cross-sectional view taken along line II-II in FIG. 1A illustrating still another example attachment feature for the sapphire cover.

FIG. 3 is a flowchart illustrating a method of attachment for the sapphire cover of FIG. 1A.

FIG. 4 illustrates an example coupling between a first member and second member.

FIG. 5A is a cross-sectional view of a sapphire cover taken along line V-V in FIG. 1B to show an alternative attachment feature.

FIG. 5B is a cross-sectional view of a sapphire cover taken along line V-V in FIG. 1B to show another alternative attachment feature.

FIG. 5C is a cross-sectional view of a sapphire cover taken along line V-V in FIG. 1B to show still another alternative attachment feature.

FIG. 6 is a flowchart illustrating an example method for attachment of the sapphire cover of FIG. 1B.

FIG. 7 is a flowchart illustrating another example method for attachment of the sapphire cover of FIG. 1B.

FIG. 8 illustrates an example extruded member.

### DETAILED DESCRIPTION

Attachment techniques for attaching materials having one or more different characteristics is provided. In one embodiment, an aperture is formed in a substrate of a first material. The aperture is filled with a second material; the second material has a lower melting point than the first material and, therefore, may be melted and poured into the aperture to fill it. The second material filling the aperture of the first material may then be used as an attachment point for other materials to mechanically couple to the first material. In one example, the first material may take the form of sapphire and the second material may take the form of a metallic material to which other materials or items may be welded, soldered, or otherwise mechanically secured.

The aperture formed in the substrate may have one or more securing features to help hold the second material within the aperture. For example, the aperture may have one or more tapered sidewalls. Alternatively, or additionally, the aperture may have a notch or step in one or more sidewalls. In still other embodiments, an interior surface of the aperture may be threaded or include a lip or protrusion that serves as a securing feature. It should be appreciated that other securing features may be implemented and, further, that multiple securing features may be used in conjunction.

In other embodiments, one or more edges of the substrate may include one or more securing features. The securing features may include notches or steps located about a periphery of the substrate, for example. A molding process may then be performed with the securing features of the substrate serving as a portion of the mold. The molding process therefore forms a molded member integral with the securing features. In some embodiments, the molding process may implement an insert molding process, an injection molding process. or the like.

With particular reference to sapphire, the presently discussed techniques allows the effective use of sapphire in a variety of different applications without the risks associated with conventional attachment techniques. For example, sapphire may effectively be attached to a frame of a mobile computing device as a cover glass for a display screen. Additionally, as sapphire's thermal conductivity is on the order of metals, it may effectively be implemented as a heat spreader. That is, sapphire may be attached both mechanically and thermally to a processor. More specifically, a sapphire substrate may be used as a processor mount to dissipate heat generated by the processor.

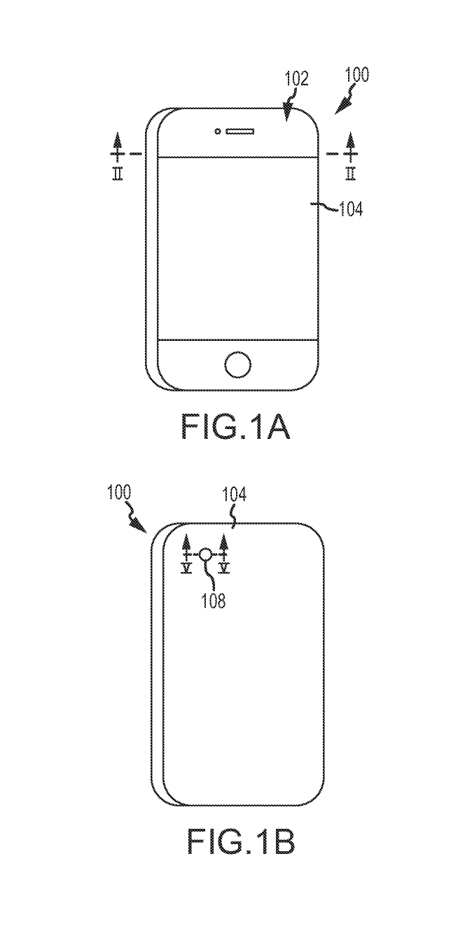

Referring to FIGS. 1A and 1B, an example mobile computing device 100 is illustrated. The mobile computing device 100 includes a first side 102 that may include a transparent cover 104. In some embodiments, the transparent cover 104 may take the form of a sapphire sheet, a sapphire sheet with a glass laminate layer, a plastic, or other suitable material, through which a visual output of the device 100 is output. Additionally, the cover 104 may be configured to receive input from users via a capacitive sensor, for example. A second side 106 (FIG. 1B) of the mobile computing device 100 includes a camera with a cover 108. As with the transparent cover 104 of the first side 102, the cover 108 may take any suitable form, such a sapphire.

As may be appreciated, the illustrated mobile computing device 100 is a smart phone, such as the iPhone® made by Apple, Inc. It should be appreciated, however, that the present techniques may be implemented in the manufacture of a variety of different devices and as such, the present discussion and accompanying drawings should be understood as non-limiting examples. For example, although the present examples discuss sapphire, it should be appreciated that it may be possible to implement the present technique effectively materials other than sapphire.

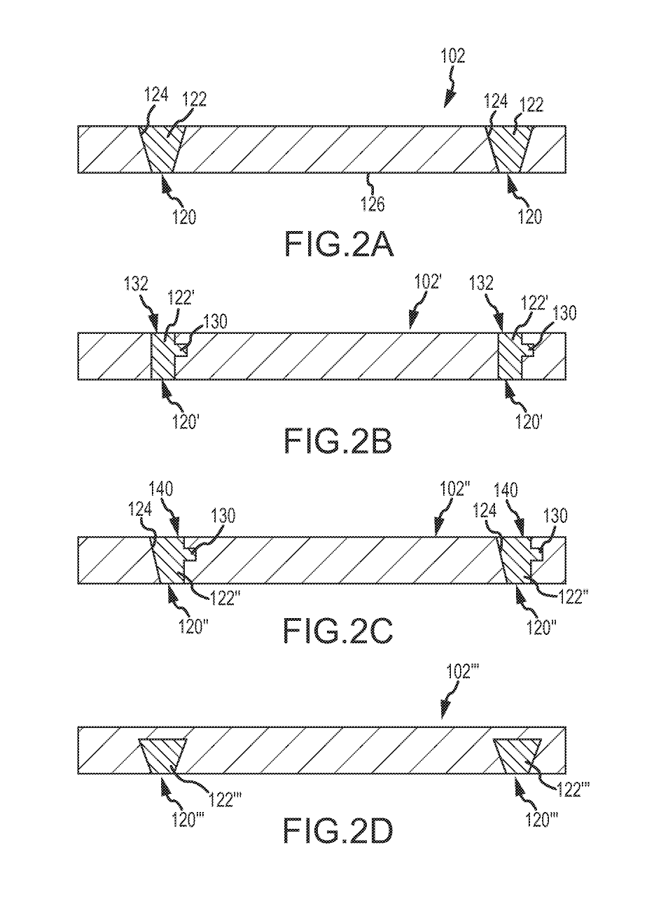

The sapphire covers 104, 108 may be coupled to the device 100 in one or more different ways. FIGS. 2A-2D are cross-sectional views of the cover 104 taken alone line II-II to show various attachment features. For example, turning to FIG. 2A, a cross sectional view of the sapphire cover 102 is illustrated as including an attachment feature 120 for mechanically coupling the sapphire cover 102 to the device 100. As shown, the attachment feature 120 takes the form of an aperture in the sapphire cover 102.

The aperture is filled with a second material 122. The second material 122 may take any suitable form and in some embodiments, it may take the form of a metallic material. Generally, the second material 122 has a lower melting point than the sapphire and therefore may be melted and poured into the aperture 120 without changing or otherwise influencing the shape and structure of the sapphire.

The aperture 120 may include one or more securing or attachment features. For example, as illustrated, the aperture 120 may include tapered sidewalls 124 to secure or hold the second material 122. Other attachment features will be discussed in greater detail below.

Once the second material 122 has cooled and hardened, the second material may be used as a coupling point for the sapphire cover. That is, the second material 122 may be used to weld, solder, braise or otherwise mechanically couple the sapphire cover 104 with another member, such as a support structure, frame, or a member coupled to a support structure or frame within the device 100. The support structure may generally be coupled to the side 126 of the cover 104 where the taper is narrowed so that the attachment to the structure is held in place by the taper. In some embodiments, the roles may be reversed so that the sapphire member serves a support structure or a part of a support structure providing stiffness and rigidity to a secondary member, such as a device housing or a portion of a device housing.

FIG. 2B is another cross-sectional view of the sapphire cover 102′ of FIG. 1 illustrating an alternative attachment feature. In particular, the attachment feature 120′ may take the form of a notch or a step 130 in and aperture 132 of the sapphire which is configured to retain the second material 122″. In other embodiments, the attachment feature may include multiple retention features, as shown in FIG. 2C. Specifically, an attachment feature 140 may include both the notch 130 and the tapered sidewall 124. It should be appreciated that the attachment feature may take any suitable form that allows for the sapphire to be secured to another structure. For example, the attachment feature may take the form of a, lip, a spiral lip, a thread, or an indentation located within the aperture configured to prevent the second material from pulling out from the aperture. Additionally, the aperture may have vertical sidewalls (e.g. non-tapered sidewalls) with other attachment features. Further, it should be appreciated that an aperture 120″′ may extend only partially into the sapphire. That is the aperture may not entirely traverse the width of the sapphire. Hence, the second material may only be exposed on one side of the sapphire member.

The aperture 120 may be created within the substrate in any suitable manner. For example, mechanical machining techniques (such as computer numerical code (CNC) machining, or other techniques) may be utilized to remove sapphire material and create the aperture 120. Additionally, or alternatively, laser ablation may be used to create the aperture. In some embodiments, the same technique is used to create the aperture 120 and the attachment feature. For example, the aperture and the attachment feature may be formed in a single laser ablation step. In other embodiments, different processes may be sequentially implemented to create the aperture and the attachment feature. For example, a CNC process may create an aperture and a laser ablation process may create one or more attachment features in the aperture.

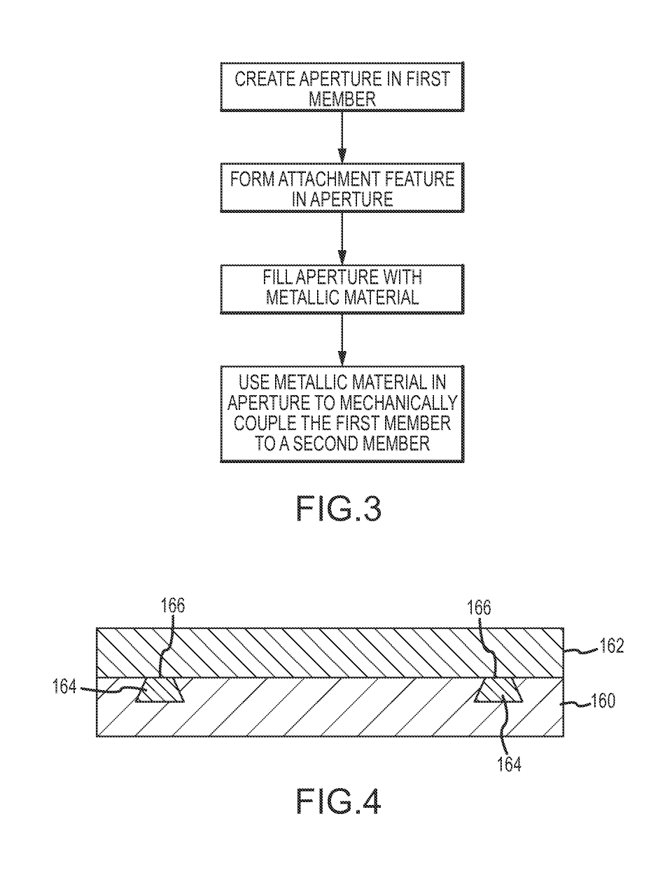

FIG. 3 is a flow chart illustrating an example method 150 of securing a sapphire substrate to a structure. Initially, the aperture is formed in a first member, e.g., the sapphire substrate, (Block 152) and the attachment feature is formed in the aperture, e.g., the tapered sidewalls or notch, (Block 154). The aperture is then filled with a second material different from the material of the first member, e.g., metallic material (Block 156). The metallic material is then used to mechanically couple the first member, e.g., the sapphire substrate, to a second member (Block 158).

referring to FIG. 4, a sapphire substrate 160 mechanically coupled with a second member 162 is illustrated. Attachment features 164 provide a surface 166 for welding, brazing, soldering or other suitable mechanical attachment of the sapphire substrate 160 with the second member 162. In one example, the second member 162 may take the form of a support structure within the device 100 that allows the sapphire substrate to be externally exposed. Advantageously, the sapphire substrate provides a resilient outer surface for interfacing a user and other objects that may scratch or otherwise damage softer material, but are unable to negatively impact the sapphire surface. In other embodiments, the sapphire substrate 160 may be utilized as a heat sink for a heat generating component, such as a processor. As such, the second member 162 may take the form of a processor or a thermal conduit coupled to a heat generating component.

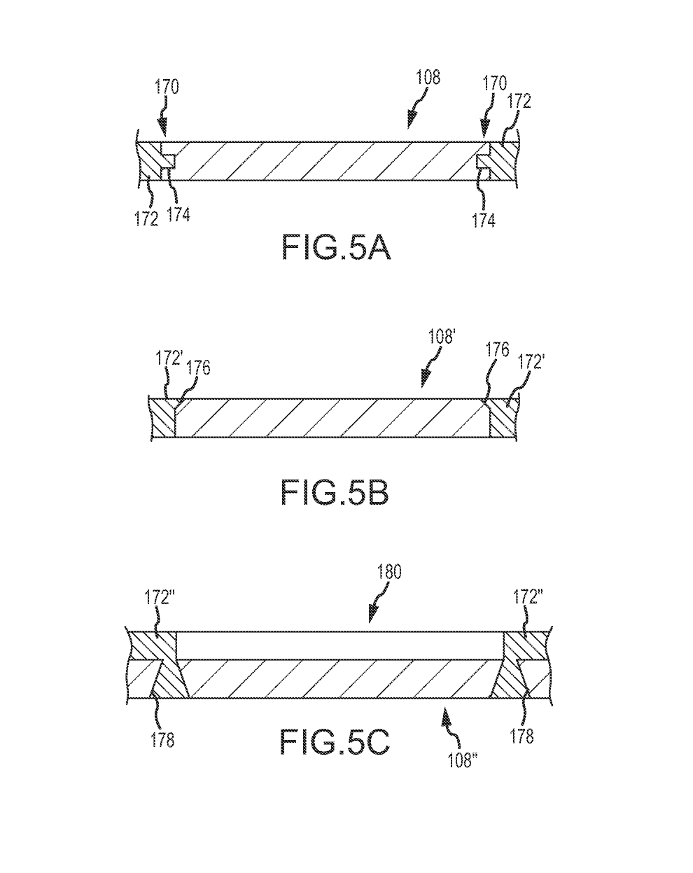

In other embodiments, the covers 104, 108 of FIGS. 1A and 1B may be attached through different processes and/or using different types of attachment features. FIGS. 5A-5C are cross sectional views of the cover 108 taken along line V-V in FIG. 1B. In particular, the embodiments of FIGS. 5A-5C may be created through a molding process, such as an injection molding process, where a portion of the sapphire cover 108 serves as part of the mold. For example, in FIG. 5A, sides 170 of the sapphire cover 108 may be used as a portion of a mold used to create a support structure 172, so that the support structure is integrated with the sapphire cover. The sides 170 may include attachment features, such as a notch 174 to secure the sapphire cover 108.

In some embodiments, the support structure 172 may form part of a housing of the device 100. As such, in some embodiments, the sapphire cover 108 is integral to the housing. In FIG. 5B, a similar process may be performed to integrate the sapphire cover 108′ with the support structure 172′. In FIG. 5B, the sapphire cover 108′ includes a chamfered edge 176 which serves as the attachment feature.

Turning to FIG. 5C, the sapphire cover 108″ includes attachment features 178 similar to those shown in FIG. 2A. An injection, blow, or insert molding process may fill the attachment features 178 (e.g., apertures 178)) and further form a support structure 172″ for the sapphire cover 108″. As illustrated, a structure may be formed adjacent a surface of the sapphire cover. An opening 180 in the support structure 172″ may provide external access to sapphire cover 108″. As may be appreciated, the molding process may be performed using any suitable material, including a variety of plastic materials. Accordingly, the support structure 172 may be a plastic.

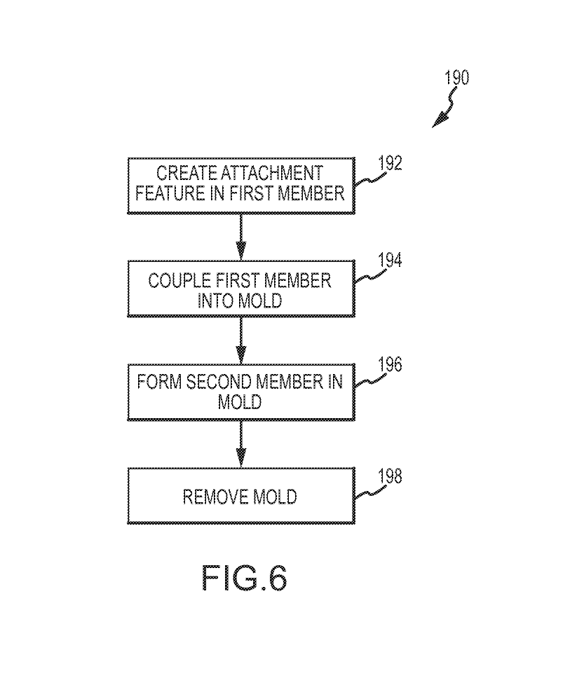

FIG. 6 is a flowchart illustrating an example method 190 for creation of the structures illustrated in FIGS. 5A-5C. Initially, an attachment member may be created within the sapphire cover or first member (Block 192). The attachment member may be created through any suitable process including those described above. The sapphire cover may be coupled into the mold for the molding process (Block 194). The sapphire cover may provide one or more surfaces for the mold used to create the support structure. The support structure or second member is then formed through a suitable molding process, such as insert molding, injection molding, blow molding, or the like (Block 196). The mold is removed to reveal the sapphire cover integrated with the support structure (Block 198).

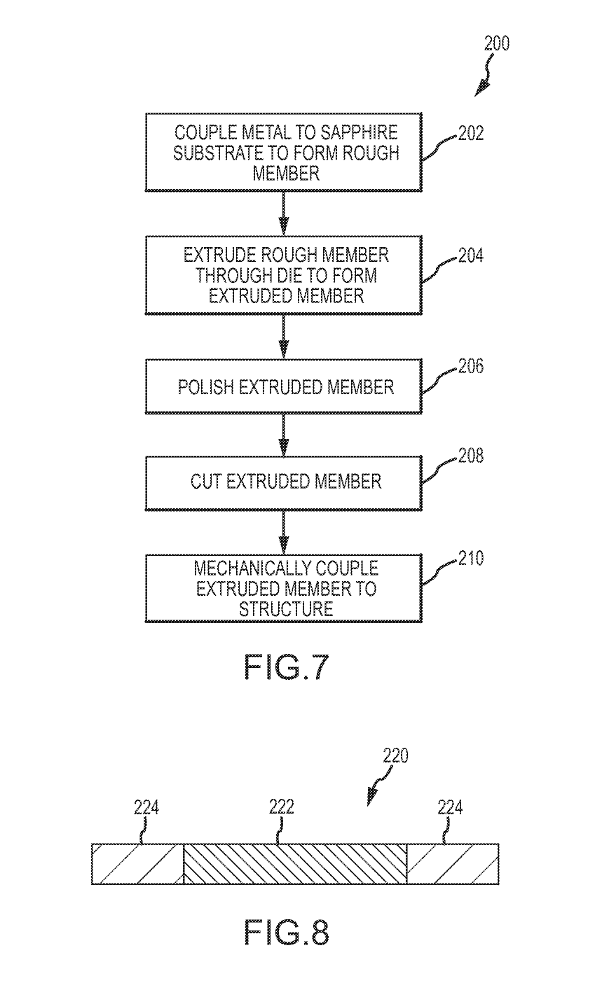

In still other embodiments, an extrusion process may be implemented to couple the covers 104, 108 to a support structure or to provide an attachment means for mechanically coupling the cover to a support structure. FIG. 7 is a flowchart illustrating steps of an example extrusion method 200. The extrusion method 200 may begin with a coupling of a metal or other material about the sapphire cover to form a rough member (Block 202). Any suitable process may be implemented to couple the metal about the sapphire. In particular, a casting technique may be implemented which could provide initial positioning of the sapphire support within the rough member to facilitate the extrusion of post processing of the extruded member. The rough member is extruded through a die to form an extruded member (Block 204). The extruded member may be polished and/or cut (Block 206 and 208). The extruded member may then be mechanically coupled to a support structure (Block 210). For example, the extruded member may be welded, soldered, or brazed to a support structure.

The attachment techniques set forth herein are not limited to the specific examples given. Indeed, the techniques may be implemented in a variety of different contexts and for various different purposes, some of which may not be explicitly set forth herein. For example, a sapphire member may be attached to a metal or plastic cover to provide stiffness. That is, the plastic or metal member may be an externally exposed portion (e.g., of an electronic device housing) and the sapphire member may be internal to the housing, but coupled to the plastic or metal member to create a more rigid structure.

FIG. 8 illustrates a cross-sectional view of an extruded member 220. The extruded member 220 may include a center sapphire portion 222 and metal member 224 located at the periphery of the sapphire portion 222. As may be seen, the sapphire portion 222 and the metal member 224 are not stacked. That is, the extrusion member provides an attachment that is only as thick as the sapphire portion 222. Generally, the extruded member may have any thickness and in some embodiments, the extruded member may be approximately 1 mm thick or less. The extruded member is held together by mechanical bonding between the sapphire and metal portions. In some embodiments, additional securing features may be implemented.

The foregoing describes some example techniques and structures for coupling of sapphire to support structures. Although the foregoing discussion has presented specific embodiments, persons skilled in the art will recognize that changes may be made in form and detail without departing from the spirit and scope of the embodiments. Accordingly, the specific embodiments described herein should be understood as examples and not limiting the scope thereof.

What is claimed is:

1. A method of attachment comprising:
creating an aperture within a sapphire substrate;
filling the aperture with an attachment material; and
mechanically coupling a member to the sapphire substrate using the attachment material.

2. The method of claim 1, wherein filling the aperture with an attachment material comprises casting a metallic material into the aperture.

3. The method of claim 2, wherein the mechanical coupling comprises at least one of: a welding process, a solder process, and a brazing process.

4. The method of claim 1, wherein the aperture comprises a securing feature.

5. The method of claim 4, wherein the securing feature comprises a tapered sidewall.

6. The method of claim 4, wherein the securing feature comprises a notch.

7. The method of claim 1, wherein filling the aperture with an attachment material comprises a molding process.

8. The method of claim 7, wherein the molding process comprises forming a feature adjacent to the surface of the sapphire substrate.

9. The method of claim 7, wherein at least one surface of the sapphire substrate serves as a portion of the mold for the molding process.

10. The method of claim 7, wherein the sapphire substrate comprises an attachment feature.

11. The method of claim 10, wherein the attachment feature comprises one of a notch, a chamfered edge, or a tapered aperture.

12. A method comprising:
creating an attachment feature in a sapphire substrate;
coupling the sapphire substrate into a mold;
forming a structure within the mold; and
removing the mold.

13. The method of claim 12, wherein creating an attachment feature comprises creating one of a chamfered edge, a notch, or a tapered aperture.

14. The method of claim 12, wherein coupling the sapphire substrate into a mold comprises coupling the sapphire substrate within the mold such that a surface of the sapphire substrate having the attachment feature serves as a mold surface for the forming of the structure.

15. The method of claim 12, wherein forming a structure within the mold comprises one of an injection molding or blow molding process.

16. The method of claim 12 further comprising coupling the structure to a device housing.

17. An extrusion method for providing attachment features for a sapphire member, the method comprising:
coupling metal about the sapphire member to form a rough member; and
extruding the rough member through a die to form an extruded member having the sapphire member mechanically bonded to the metal.

18. The method of claim 17 further comprising:
polishing the extruded member; and
cutting the extruded member.

19. A device comprising a mechanical coupling between two materials, the device comprising:
a first member comprising one or more attachment features, the attachment features being filled with one of a plastic or a metal; and
a second member coupled to the first member by the plastic or metal.

20. The device of claim 19, wherein the first member comprises sapphire.

21. The device of claim 20, wherein the one or more attachment features comprises at least one of a tapered aperture, a notch, or a chamfered edge.

22. The device of claim 20, wherein the second member comprises a plastic if the fill material is plastic and a metal if the fill material is metal.
